(19) United States
(12) Patent Application Publication
(10) Pub. No.: US 2005/0216578 A1
(43) Pub. Date: Sep. 29, 2005

(54) Methods, devices and computer program products using a node affiliation protocol for monitoring and/or controlling networkable devices

(76) Inventor: Jim Thompson, Raleigh, NC (US)

Correspondence Address: Robert M. Meeks;Myers Bigel Sibley & Sajovec, P.A., Post Office Box 37428, Raleigh, NC, 27627, US

(21) Appl. No.: 10/811,708

(22) Filed: Mar. 29, 2004

(51) Int. Cl. G06F 15/173

(52) U.S. Cl. 709/223

(57) ABSTRACT

Communication between a networkable device, such as a UPS, and a supervisory device, such as a PDA or cellphone configured to monitor and/or control the UPS, is managed. An affiliation request message is transmitted from the networkable device, the affiliation request message requesting an affiliation request response from another networkable device. An affiliation request response status for the transmitted affiliation request message is determined. The networkable device is transitioned to an affiliation state responsive to the determined affiliation request response status. The networkable device and the supervisory device communicate based on the affiliation state. For example, in some embodiments, if at least one affiliation request response message identifying a second networkable device is received, the networkable device is transitioned to a governed state with respect to a second networkable device, and the first networkable device and the supervisory device communicate via the second networkable device responsive to the governed state of the first networkable device.

### BACKGROUND OF THE INVENTION

The present invention relates to computer apparatus, methods and computer program products, and more particular, to supervisory communications for networkable devices, such as uninterruptible power supplies.

Networkable devices, such as uninterruptible power supplies (UPSs), commonly have the capability to communicate with external monitor/controller. For example, as shown in FIG. 1, UPSs 110 may include web cards 112 that are configured to generate status e-mail messages 115 addressed to external devices, such as a PC 120 or a personal digital assistant (PDA) 130. Similarly, the external devices may be configured to send control information, such as commands that cause the UPSs 110 to perform certain functions, using similar e-mail messaging techniques. As shown, such e-mail messages 115 are typically communicated over a internet protocol (IP) network 140, which may include other monitored devices 150 (e.g., computers, printers, data storage devices, and the like), as well as communications components, such as a wireless base station 160.

A potential drawback of such an approach in some applications is that it may lead to the generation of unnecessary and redundant e-mail messages. For example, in many network applications, a large number of UPSs may be used to provide uninterruptible power to devices such as user workstations, servers, disk arrays, and other network elements. In the event of a failure in the AC utility grid, a large number of these UPSs may be affected. Using a conventional status messaging approach as shown in FIG. 1, this may lead to the transmission of a large number of separate status e-mail messages addressed to a monitoring device (e.g., an IT manager's PDA), even though each of these status e-mail messages may relate to the same event.

### SUMMARY OF THE INVENTION

According to some embodiments of the invention, communication between a networkable device, such as a UPS, and a supervisory device, such as a PDA or cellphone configured to monitor and/or control the UPS, are managed. An affiliation request message is transmitted from the networkable device, the affiliation request message requesting an affiliation request response from another networkable device.

An affiliation request response status for the transmitted affiliation request message is determined. The networkable device is transitioned to an affiliation state responsive to the determined affiliation request response status. The networkable device and the supervisory device communicate based on the affiliation state. For example, in some embodiments, if at least one affiliation request response message identifying a second networkable device is received, the networkable device is transitioned to a governed state with respect to a second networkable device, and the first networkable device and the supervisory device communicate via the second networkable device responsive to the governed state of the first networkable device. In other embodiments, in response to detecting a failure to receive a response to the affiliation request message according to a predetermined failure criterion, the networkable device transitions to a governor state and communicates directly with the supervisory device.

According to further aspects of the invention, communications of an uninterruptible power supply (UPS) are managed. An affiliation request message is transmitted from the UPS, the affiliation request message requesting an affiliation request response from another networkable device. The UPS determines an affiliation request response status for the transmitted affiliation request message. The UPS transitions to an affiliation state responsive to the determined affiliation request response status, and communicates with a supervisory device configured to control and/or monitor the UPS based on the affiliation state.

According to further embodiments of the invention, a device, such as UPS, includes functional electronic circuitry, such as power conversion circuitry. The device further includes a communication circuit operatively associated with the functional electronic circuitry and configured to transmit an affiliation request message requesting an affiliation request response from a networkable device, to determine an affiliation request response status for the transmitted affiliation request message, to transition to an affiliation state responsive to the determined affiliation request response status, and to communicate with a supervisory device regarding the functional electronic circuitry based on the affiliation state.

In still further embodiments of the invention, A computer program product for managing communication between a networkable device and supervisory device configured to monitor and/or control the networkable device is provided. The computer program product includes program code embodied in a computer readable medium. The program code includes program code configured to transmit an affiliation request message from a networkable device, program code configured to determine an affiliation request response status for the transmitted affiliation request message, program code configured to transition the networkable device to an affiliation state responsive to the determined affiliation request response status, and program code configured to route communications between the networkable device and a supervisory device based on the affiliation state.

### BRIEF DESCRIPTION OF THE DRAWINGS

FIG. 1 illustrates a conventional status messaging approach.

FIG. 2 illustrates devices and methods for supervisory communications according to some embodiments of the invention.

FIG. 3 illustrates exemplary state transitions for a networkable device according to further embodiments of the invention.

FIG. 4 illustrates exemplary operations for determining affiliation state according to further aspects of the invention.

FIG. 5 illustrates exemplary governor device operations according to some embodiments of the invention.

FIG. 6 illustrates exemplary governed device operations according to some embodiments of the invention.

FIG. 7 illustrates broadcast of affiliation request messages and response thereto according to further embodiments of the invention.

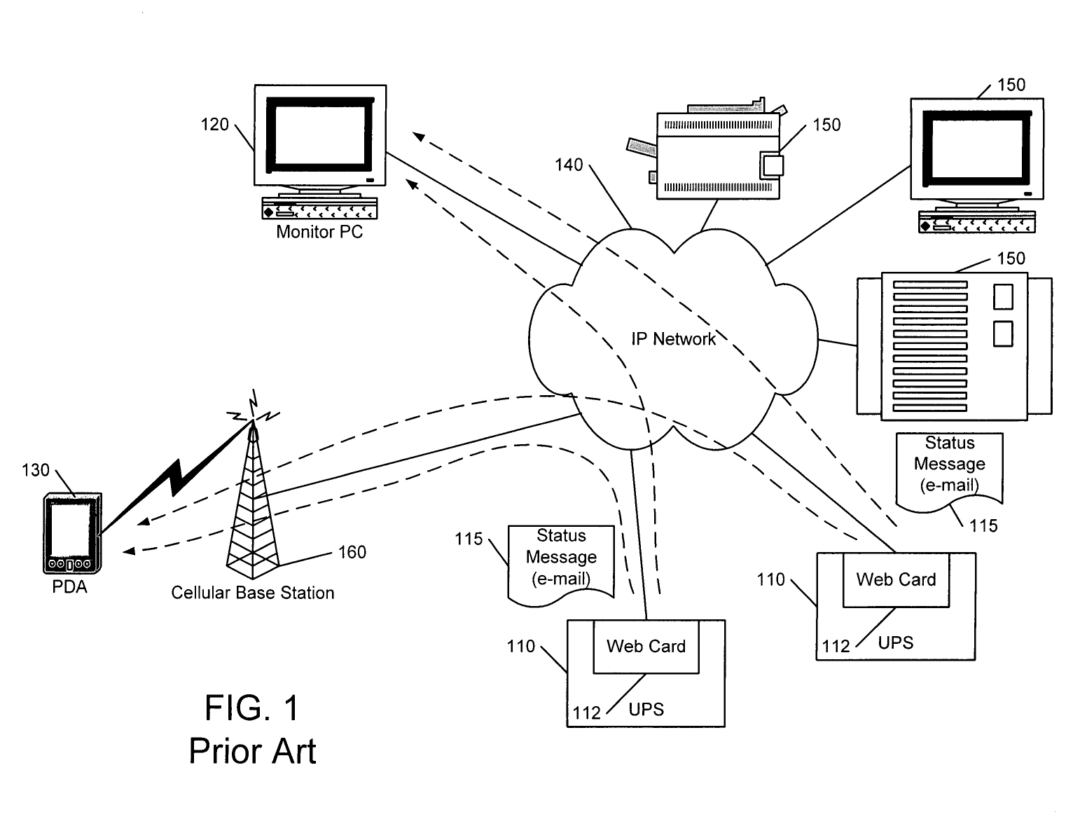

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present.

The following discussion relates to operations for affiliating networkable devices and for communicating information according to the affiliations. As used herein, “networkable” devices are devices that are configurable to communicate with similar devices in various network configurations. Such devices include devices designed to be connected in a network in a relatively fixed fashion, such as computers, printers, disk drives, and the like, as well as devices configured to join networks in a dynamic fashion, such as devices configured to use wireless networks conforming to various wireless cellular communications standards (e.g., GSM, IS-136, IS-95, UMTS) or various wireless networking standards (e.g., 802.11b/g, Bluetooth). These include, but are not limited to, devices configured to join “ad hoc” networks, such as wireless piconets.

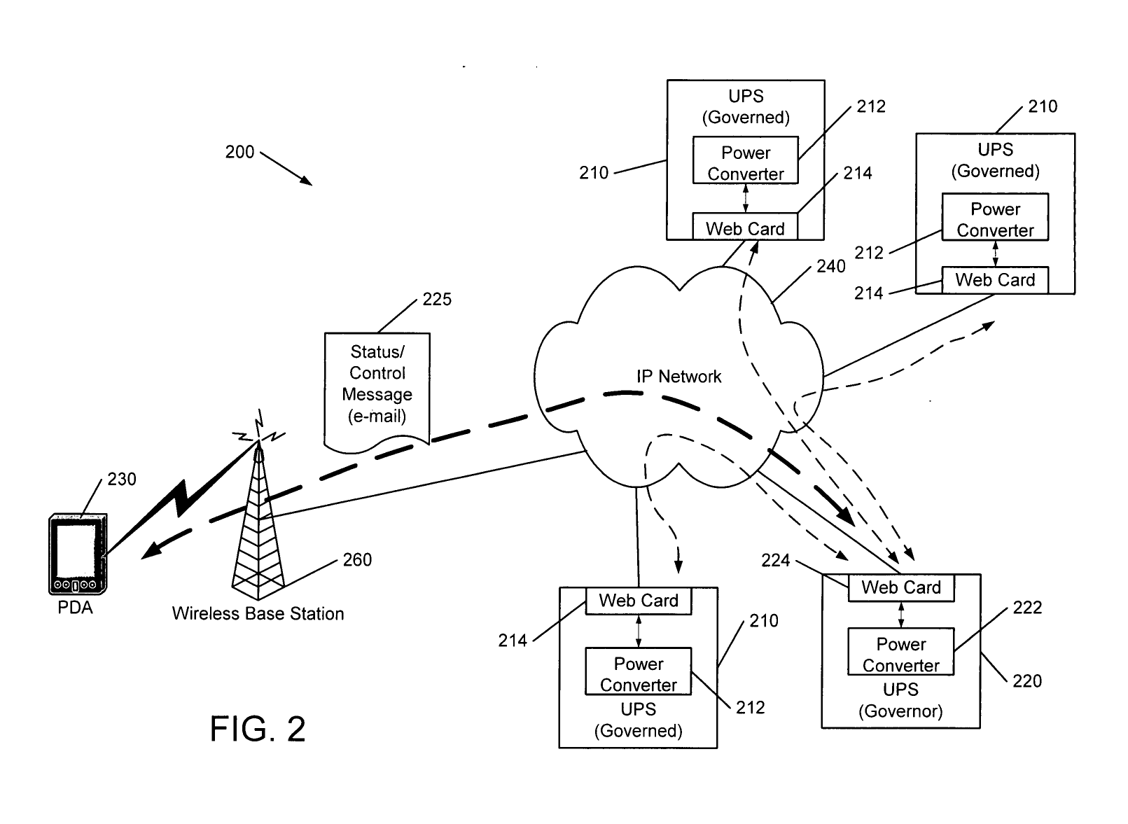

In the present application, FIGS. 2-7 are diagrams illustrating exemplary apparatus and operations according to embodiments of the present invention. It will be understood that operations depicted in the diagrams, and combinations thereof, may be implemented using one or more electronic circuits, for example, in a communications circuit of a networkable device, such as a UPS, networked computer, or network appliance. It will also be appreciated that, in general, operations depicted in the diagrams, and combinations thereof, may be implemented in one or more electronic circuits, such as in one or more discrete electronic components, one or more integrated circuits (ICs), one or more application specific integrated circuits (ASICs), and application specific circuit modules, as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the specified operations. The computer program instructions may also be executed on one or more computers or other data processing apparatus to cause a series of actions to be performed by the computer(s) or other programmable apparatus to produce a computer implemented process that includes the specified operations.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical or other storage media, such as a magnetic or optical disk or an integrated circuit memory device. For example, the computer program instructions may be embodied in memory included in a device, such as a computer or UPS. Accordingly, blocks of the diagrams of FIGS. 2-7 support electronic circuits and other apparatus that perform the specified operations, acts for performing the specified operations, and computer program products configured to perform the specified operations.

FIG. 2 illustrates a system 200 according to some embodiments of the present invention. A plurality of “governed” networkable devices include UPSs 210 including respective power converter circuits 212 and web cards 214 that are configured to send and/or receive status and/or control information regarding the power converter circuits 212. The governed UPSs 210 (e.g., the web cards 214 thereof) communicate via a “governor” device, shown as another UPS 220 including a power converter circuit 222 and a web card 224, over an IP network 240. The governor UPS 220 (e.g., the web card 224 thereof) may be configured to convey status information received from the governed devices 210 to a supervisory device, shown as a PDA 230 coupled to the IP network 240 via a wireless base station 260. The governor UPS 220 may be also be configured to convey control information from the supervisory device 230 to the governed devices 210. For example, according to some embodiments of the invention, the governor UPS 220 may be configured to combine status information from the multiple governed devices 210 in a single electronic message, such as an e-mail message 225 or an SNMP trap. Similarly, a single message transmitted from the supervisory device 230 to the governor UPS 220 may include control information pertinent to the multiple governed devices 210. Using such an approach, redundant information transfer to and/or from the supervisory device 230 may be reduced.

It will be appreciated that the embodiments of FIG. 2 are shown for exemplary purposes, and that the invention is not limited to such an implementation. For example, although the use of governor/governed affiliations among UPSs 210, 220 is shown in FIG. 2, it will be appreciated that the invention is not limited to use with UPSs. In particular, techniques within the scope of the present invention are equally applicable to other types of networkable devices including supervised functional circuitry other than power conversion circuitry, including, but not limited to, communications devices, computers, printers, storage devices, network components (e.g., routers and switches), and network appliances.

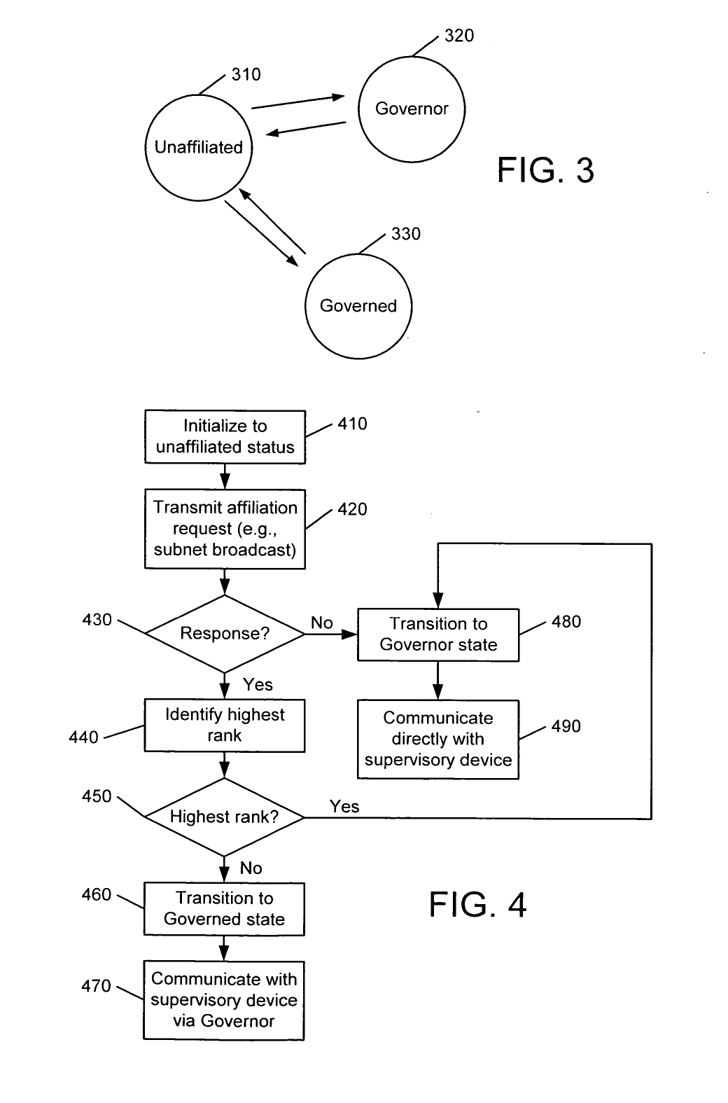

FIG. 3 illustrates exemplary affiliation states through which a networkable device may transition according to further aspects of the invention. Upon, for example, powerup or reset, a device may initialize to an unaffiliated state. From this unaffiliated state, the device may transition to either a “governor” state 320, i.e., a state in which the device collects status information from various governed devices, or a “governed” state 330, i.e., a state in which the device transmits status information via a governor device. Upon occurrence of certain events, such as the events described below, the device may transition back to the unaffiliated state 310 from either of the governor or governed states 320, 330.

FIG. 400 illustrates exemplary operations for transitioning among unaffiliated, governor and governed states. After transition to an unaffiliated state (block 410), e.g., upon powerup, reset, or transition from a governed or governor state, a device transmits an affiliation request message (block 420), i.e., a message requesting a response from a device suited to be a governor. For example, for a device deployed in an IP network, the affiliation request message may be a broadcast message transmitted over an IP subnet to which the device is attached. If one or more appropriate responses are received (block 430), the receiving device determines which of the responding devices has the highest rank (block 440). The ranking may be based on any of a number of different parameters, such as device type IP address or the like.

The device may then determine whether it outranks the highest ranked device (block 450). If not, the device transitions to a governed state (block 460), in which it is governed by the highest-ranking responding device. The governed device then communicates with a supervisory device (e.g., sends status info and./or receives control commands) via the governor device (block 470). For example, in such a state, the governed device may transmit an e-mail or other message including status information to the governor device, which may be configured to extract the status information and to combine the extracted status information with information received from other governed devices in a status email or other message that is addressed to the supervisory device. Similarly, the supervisory device may transmit an e-mail including control information relating to multiple governed devices to the governor device, and the governor device may extract information from the received e-mail and included it in respective e-mails or other messages transmitted to the respective governed devices.

If the device determines that it is the highest-ranking device (block 450) or if no appropriate response to the transmitted affiliation request message is received (block 430), the device transitions to a governor state (block 480). Such a failure may comprise, for example, passage of a predetermined timeout interval without receipt of an appropriate affiliation request response message and/or a failure to receive an appropriate response to a predetermined number of affiliation request messages. In the governor state, the device communicates directly with the external device (e.g., by sending and receiving e-mail directly to and from the external device) (block 490). As described herein, “direct” communication refers to acts wherein status information and/or control information relating to a monitored and/or controlled device is directly addressed between the monitored and/or controlled device and the supervisory device that monitors and/or controls it. It will be appreciated that, in some embodiments of the invention, such “direct” communication may occur via intermediate network nodes, for example, intermediate nodes of an IP network.

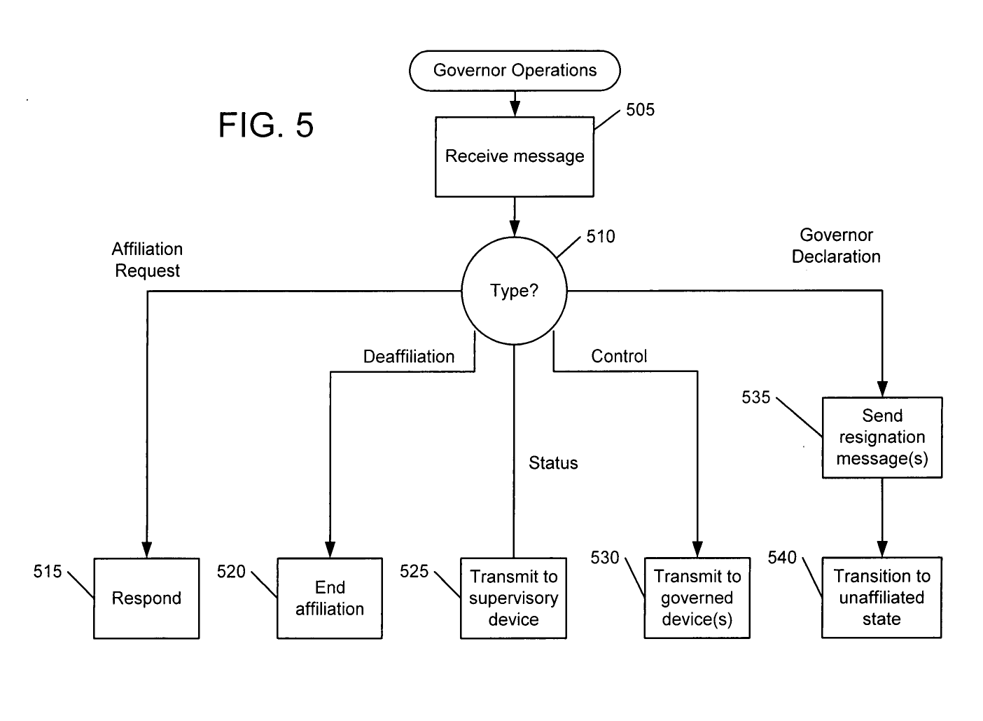

FIG. 5 illustrates exemplary operations of a governor device according to further aspects of the invention. Upon receipt of a message (block 505), the governor device determines what type of message has been received (block 510). If the message is an affiliation request from an unaffiliated device, the governor device responds accordingly (block 515), i.e., transmits an affiliation request response message. If the received message is a de-affiliation message from a governed device, the governor device ends the affiliation (e.g., removes the governed device from a list of governed devices) (block 320). If the received message is a status message from governed device, the governor device transmits the status information to a supervisory device, e.g., in an e-mail including status information for multiple governed devices (block 325). If the received message is a control message from a supervisory device, the governor may convey the control information onto its governed nodes (block 330). If the received message is a governor declaration from a superior governor device, the receiving governor device sends one or more resignation messages to its governed devices (block 335) and transitions to an unaffiliated state (block 340).

It will be appreciated that actions responsive to receipt of such a governor declaration message may be carried out in any of a number of different ways within the scope of the invention. For example, in some embodiments, a resignation message sent by a governor to its governed nodes may include a reason code, which indicates whether the resignation is based on inferiority, along with a data segment that includes the address of the superior governor. The receiving governed nodes could use this address to establish an affiliation with the new governor.

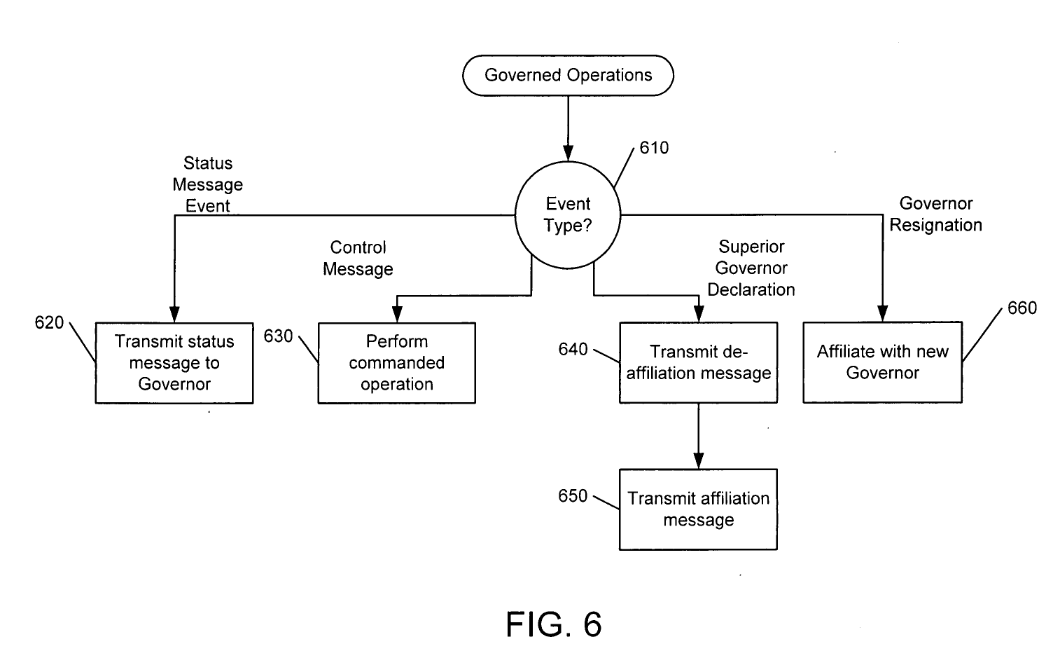

FIG. 6 illustrates exemplary operations of a governed device according to some embodiments of the invention. In response to an event, the governed device determines an appropriate action based on the event type (block 610). If the event is a status event (e.g., a change in state of the circuitry, such as UPS circuitry, being monitored), the governed device transmits an appropriate message to its current governor device (block 620). If the event is receipt of a control message from the governor, the governed node performs the commanded action (block 630). If the event is receipt of a governor declaration from a governor that is superior to the current governor, the governed device transmits a resignation message to its current governor (block 640), and establishes an affiliation with the new governor (block 650). If the event is receipt of a resignation message from its current governor indicating detection of a superior governor, the governed node affiliates with the new governor identified in the message (block 660).

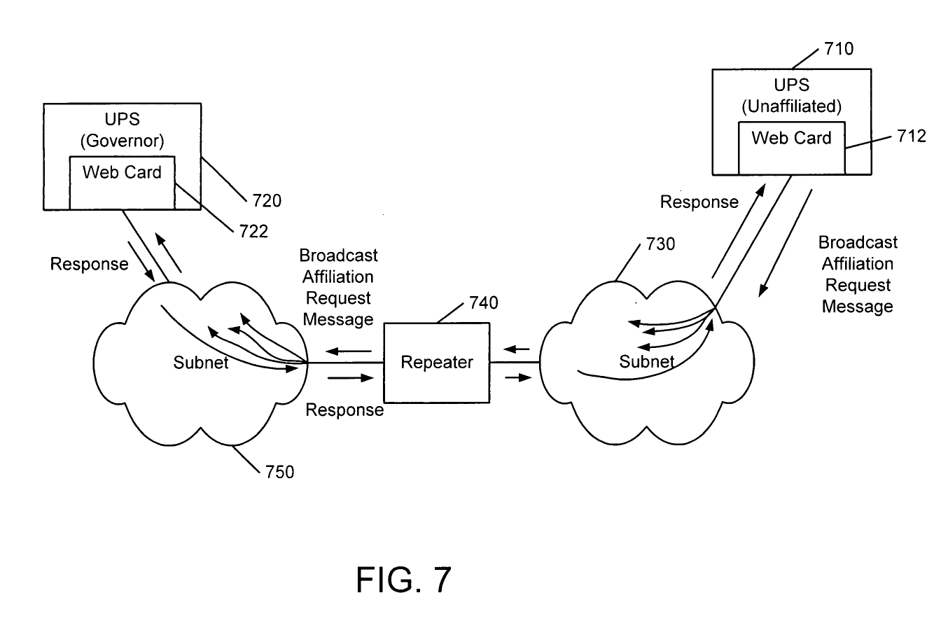

According to various aspects of the invention, affiliations may be limited to a particular portion of a network, e.g., a particular subnet in an IP network, or may be distributed across multiple portions of the network. For example, as shown in FIG. 7, a broadcast affiliation message transmitted in a first subnet 730 by an unaffiliated device, here a UPS 710 including a web card 712, is received by a repeater device 740. The repeater device 740 may be aware of a suitable governor device on a second subnet 750, here a UPS 720 with a web card 722, and may cause broadcast of the affiliation request message on the second subnet 750. A governed/governor relationship may then be established between the two devices 710, 720 by transmission of an appropriate affiliation request response from the device 720, along lines discussed above.

In the drawings and specification, there have been disclosed exemplary embodiments of the invention. Although specific terms are employed, they are used in a generic and descriptive sense only and not for purposes of limitation, the scope of the invention being defined by the following claims.

1. A method of managing communication between a networkable device and a supervisory device configured to monitor and/or control the networkable device, the method comprising:
transmitting an affiliation request message from the networkable device, the affiliation request message requesting an affiliation request response from another networkable device;
determining an affiliation request response status for the transmitted affiliation request message;
transitioning the networkable device to an affiliation state responsive to the determined affiliation request response status; and
communicating between the networkable device and the supervisory device based on the affiliation state.

2. A method according to claim 1:
wherein the networkable device comprises a first networkable device;
wherein determining an affiliation request response status comprises receiving at least one affiliation request response message identifying a second networkable device;
wherein transitioning the networkable device to an affiliation state comprises adopting a governed state for the first networkable device with respect to the second networkable device responsive to receiving the at least one affiliation request response message; and
wherein communicating between the networkable device and the supervisory device comprises communicating between the first networkable device and the supervisory device via the second networkable device responsive to the governed state of the first networkable device.

3. A method according to claim 2:
wherein receiving at least one affiliation request response message identifying a second networkable device comprises receiving respective affiliation responses to the affiliation request message from respective ones of a plurality of second networkable devices; and
wherein adopting a governed state comprises:
selecting one of the second networkable devices; and
adopting a governed state for the first networkable device in relation to the selected second networkable device.

4. A method according to claim 3, wherein selecting one of the second networkable devices comprises selecting one of the second networkable devices based on at least one attribute thereof according to a predetermined selection rule.

5. A method according to claim 2, further comprising:
receiving a resignation message from the second networkable device;
adopting a new governed state for the first networkable device in relation to a third networkable device identified in the resignation message; and
communicating between the first networkable device and the supervisory device via the third networkable device responsive to the new governed state of the first networkable device.

6. A method according to claim 2, wherein communicating between the first networkable device and the supervisory device comprises communicating status and/or control information regarding the first networkable device in an electronic message communicated between the second networkable device and the supervisory device.

7. A method according to claim 1:
wherein determining an affiliation request response status comprises detecting a failure to receive a response to the affiliation request message according to a predetermined failure criterion;
wherein transitioning the networkable device to an affiliation state comprises transitioning the networkable device to a governor state responsive to detecting the failure to receive a response to the affiliation request message; and
wherein communicating comprises communicating directly between the networkable device and the supervisory device responsive to the governor state.

8. A method according to claim 7, wherein the failure criterion comprises at least one of a passage of a response interval and a number of failures to receive responses to affiliation request messages.

9. A method according to claim 7, wherein the networkable device comprises a first networkable device, and further comprising:
receiving a governor declaration message from a second networkable device at the first networkable device; and
transitioning the first networkable device to an unaffiliated state responsive to receiving the governor declaration message.

10. A method-according to claim 9, wherein-transitioning-the first networkable device to an unaffiliated state comprises transitioning the first networkable device to the unaffiliated state if the governor declaration message meets a predetermined criterion.

11. A method according to claim 9, further comprising transmitting at least one resignation message to at least one third networkable device responsive to receiving the governor declaration message.

12. A method according to claim 1, wherein the networkable device comprises a node of an internet protocol (IP) network.

13. A method according to claim 12, wherein transmitting an affiliation request message comprises broadcasting the affiliation request message to devices of a first subnet including the networkable device.

14. A method according to claim 13, wherein transmitting an affiliation request message comprises broadcasting the affiliation request message to devices of a second subnet via a repeater node in the first subnet.

15. A method according to claim 1, wherein the networkable device comprises an uninterruptible power supply.

16. A method according to claim 1, wherein transmitting an affiliation request message comprises transmitting the affiliation request message over at least one of a wireless transmission medium, a wireline transmission medium, and an optical transmission medium.

17. A method of managing communications of an uninterruptible power supply (UPS), the method comprising:
transmitting an affiliation request message from the UPS, the affiliation request message requesting an affiliation request response from another networkable device;
determining an affiliation request response status for the transmitted affiliation request message;
transitioning the UPS to an affiliation state responsive to the determined affiliation request response status; and
communicating between the UPS and a supervisory device configured to control and/or monitor the UPS based on the affiliation state.

18. A method according to claim 17:
wherein determining an affiliation request response status comprises receiving at least one affiliation request response message identifying a second networkable device;
wherein transitioning the networkable device to an affiliation state comprises adopting a governed state for the UPS in relation to the second networkable device responsive to receiving the at least one affiliation request response message; and
wherein communicating between the UPS and the supervisory device comprises communicating between the UPS and the supervisory device via the second networkable device responsive to the governed state of the UPS.

19. A method according to claim 18, wherein communicating between the UPS and the supervisory device via the second networkable device comprises including status and/or control information regarding the UPS in an electronic message communicated between the second networkable device and the supervisory device.

20. A method according to claim 18, wherein the second networkable device comprises a second UPS.

21. A method according to claim 17:
wherein determining an affiliation request response status comprises detecting a failure to receive a response to the affiliation request message according to a predetermined failure criterion;
wherein transitioning the UPS to an affiliation state comprises transitioning the UPS to a governor state responsive to detecting the failure to receive a response to the affiliation request message; and
wherein communicating between the UPS and a supervisory device comprises communicating directly between the UPS and the supervisory device responsive to the governor state.

22. A method according to claim 17, wherein the UPS comprises a node of an internet protocol (IP) network.

23. A method according to claim 22, wherein transmitting an affiliation request message comprises broadcasting the affiliation request message to devices of a first subnet including the UPS.

24. A method according to claim 23, wherein transmitting an affiliation request message comprises conveying the affiliation request message to a second subnet via a repeater in the first subnet.

25. A device, comprising:
functional electronic circuitry; and
a communication circuit operatively associated with the functional electronic circuitry and configured to transmit an affiliation request message requesting an affiliation request response from a networkable device, to determine an affiliation request response status for the transmitted affiliation request message, to transition to an affiliation state responsive to the determined affiliation request response status, and to communicate with a supervisory device regarding the functional electronic circuitry based on the affiliation state.

26. A device according to claim 25, wherein the communications circuit is configured to receive at least one affiliation request response message identifying a networkable device, to adopt a governed state with respect to the networkable device responsive to receiving the at least one affiliation request response message and to communicate with the supervisory device via the networkable device responsive to the governed state.

27. A device according to claim 25, wherein the communications circuit is configured to detect a failure to receive a response to the affiliation request message according to a predetermined failure criterion, to transition to a governor state responsive to detecting the failure to receive a response to the affiliation request message, and to directly communicate with the supervisory device responsive to the governor state.

28. A device according to claim 25, wherein the communications circuit comprises a communications circuit that serves as a node of an internet protocol (IP) network.

29. A device according to claim 25, wherein the functional circuitry comprises uninterruptible power supply circuitry.

30. An uninterruptible power supply (UPS), comprising:
power conversion circuitry; and
a communication circuit operatively associated with the power conversion circuitry and configured to transmit an affiliation request message requesting an affiliation request response from a networkable device, to determine an affiliation request response status for the transmitted affiliation request-message, to transition to an affiliation state responsive to the determined affiliation request response status, and to communicate with a supervisory device regarding the power conversion circuitry based on the affiliation state.

31. A device according to claim 30, wherein the communications circuit is configured to receive at least one affiliation request response message identifying a networkable device, to adopt a governed state in relation to the networkable device responsive to receiving the at least one affiliation request response message and to communicate with the supervisory device via the networkable device responsive to the governed state.

32. A device according to claim 30, wherein the communications circuit is configured to detect a failure to receive a response to the affiliation request message according to a predetermined failure criterion, to transition to a governor state responsive to detecting the failure to receive a response to the affiliation request message, and to directly communicate with the supervisory device responsive to the governor state.

33. A device according to claim 30, wherein the communications circuit comprises a Web card configured to serve as a node of an internet protocol (IP) network.

34. A computer program product for managing communication between a networkable device and supervisory device configured to monitor and/or control the networkable device, the computer program product comprising program code embodied in a computer readable medium, the program code comprising:
program code configured to transmit an affiliation request message from a networkable device, the affiliation request message requesting an affiliation request response from another networkable device;
program code configured to determine an affiliation request response status for the transmitted affiliation request message;
program code configured to transition the networkable device to an affiliation state responsive to the determined affiliation request response status; and
program code configured to route communications between the networkable device and a supervisory device based on the affiliation state.

35. A computer program product according to claim 34:
wherein the networkable device comprises a first networkable device;
wherein the program code configured to determine an affiliation request response status comprises program code configured to receive at least one affiliation request response message identifying a second networkable device;
wherein the program code configured to transition the networkable device to an affiliation state comprises program code configured to adopt a governed state for the first networkable device in relation to the second networkable device responsive to receiving the at least one affiliation request response message; and
wherein the program code configured to route communications comprises program code configured to route communications between the first networkable device and the supervisory device via the second networkable device responsive to the governed state of the first networkable device.

36. A computer program product according to claim 34:
wherein the program code configured to determine an affiliation request response status comprises program code configured to detect a failure to receive a response to the affiliation request message according to a predetermined failure criterion;
wherein the program code configured to transition the networkable device to an affiliation state comprises program code configured to transition the networkable device to a governor state responsive to detecting the failure to receive a response to the affiliation request message; and
wherein the program code configured to route communications comprises program code configured to directly route communications between the networkable device and the supervisory device responsive to the governor state.
